(19) United States
(12) Patent Application Publication
(10) Pub. No.: US 2019/0111504 A1
(43) Pub. Date: Apr. 18, 2019

(54) Transmission Device For a Table Saw

(71) Applicant: P&F Brother Industrial Corporation, Taichung (TW)

(72) Inventor: Mei-Lan Kao, Taichung (TW)

(21) Appl. No.: 15/865,542

(22) Filed: Jan. 9, 2018

(30) Foreign Application Priority Data
Oct. 17, 2017 (TW) 106135505

(51) Int. Cl. B23D 47/12; B23D 45/06; B27B 5/32

(52) U.S. Cl. CPC B23D 47/12; B27B 5/32; B23D 45/068

(57) ABSTRACT

A transmission device is adapted for use in a table saw, and includes a bracket and a lifting seat that is movably mounted to the bracket. The transmission device includes a motor, a speed reduction unit, and a saw blade unit. The motor is adapted to be mounted to the lifting seat and has a rotatable central shaft. The speed reduction unit is adapted to be mounted to the lifting seat, is connected to the central shaft, and is driven rotatably by the motor. The saw blade unit includes an output shaft adapted for connection to the lifting seat, extending along a second axis, and driven by the speed reduction unit, and a blade member connected co-rotatably to the output shaft, and having a portion that is adapted to be received in the bracket.

### CROSS-REFERENCE TO RELATED APPLICATION

This application claims priority of Taiwanese Patent Application No. 106135505, filed on Oct. 17, 2017.

### FIELD

The disclosure relates to a transmission device, and more particularly to a transmission device for a table saw.

### BACKGROUND

A conventional table saw includes a machine seat having a working table, a bracket mounted to the machine seat, a lifting seat mounted to the bracket, a driving unit connected to the bracket and the lifting seat for driving vertical movement of the lifting seat relative to the bracket, a saw blade unit having a blade member and an output shaft, and a transmission unit disposed for driving rotation of the saw blade unit. The transmission unit includes a motor that is mounted to the lifting seat and that has a rotatable central shaft, a driving wheel that is connected co-rotatably to the central shaft, and a driven wheel that is coaxially connected to the driving wheel and that is fixedly coupled to the output shaft, such that the output shaft is driven rotatably by the motor.

In conformity with safety regulation of the table saw, the diameter of the blade member and the area of the top surface of the working table are required to be in direct proportion. As such, the conventional table saw having a relatively large blade member is required to be matched with a relatively large working table, which leads to higher cost in packaging and transportation. While the blade member can be modified to be smaller in size, it may not be suitable for cutting a relatively thick workpiece. In addition, such coaxial configuration between the central shaft of the motor and the output shaft of the saw blade unit may cause undesired contact of a top end of the motor with a bottom surface of the working table during movement of the lifting seat.

Taiwanese Utility Model Patent Nos. M346476 and M314086 disclosed another conventional table saw which includes a motor having a central shaft, a pulley unit connected rotatably to the motor, a belt trained on the pulley unit, and a saw blade unit driven rotatably by the pulley unit. Since the central shaft is disposed under the saw blade unit (i.e., the central shaft and the saw blade unit are in vertical alignment), the drawback (i.e., contact of the motor and the working table) associated with the previous conventional table saw may be avoided. However, such conventional table saw is inconvenient to store or transport due to its great dimension, particularly in the vertical direction.

### SUMMARY

Therefore, an object of the disclosure is to provide a transmission device that can alleviate the drawback associated with the abovementioned prior arts.

Accordingly, the transmission device is adapted for use in a table saw. The table saw includes a machine seat, a bracket that is mounted to the machine seat, a lifting seat that is movably mounted to the bracket, and a driving unit that is connected to the bracket and the lifting seat and that is operable to drive vertical movement of the lifting seat. The transmission device includes a motor, a speed reduction unit, and a saw blade unit. The motor is adapted to be mounted to the lifting seat, and has a central shaft that extends rotatably along a first axis. The speed reduction unit is adapted to be mounted to the lifting seat, is connected to the central shaft, and is driven rotatably by the motor. The saw blade unit includes an output shaft and a blade member. The output shaft is adapted for connection to the lifting seat, extends along a second axis, and is driven rotatably by the speed reduction unit. The blade member is connected co-rotatably to the output shaft, and has a portion adapted to be received in the bracket.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a first embodiment of a transmission device according to the present disclosure mounted in a table saw;

FIG. 2 is a partly exploded perspective view of the first embodiment alongside a bracket and a driving unit of the table saw;

FIG. 3 is a side view of the first embodiment alongside the bracket, the driving unit and a lifting seat of the table saw, illustrating the lifting seat at a lifted position;

FIG. 4 is an exploded perspective view of the first embodiment;

FIG. 5 is a side view of the first embodiment;

FIG. 6 is a view similar to FIG. 3, but illustrating the lifting seat at a lowered position;

FIG. 7 is a side view of a second embodiment of the transmission device according to the present disclosure; and

FIG. 8 is a side view of a third embodiment of the transmission device according to the present disclosure.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

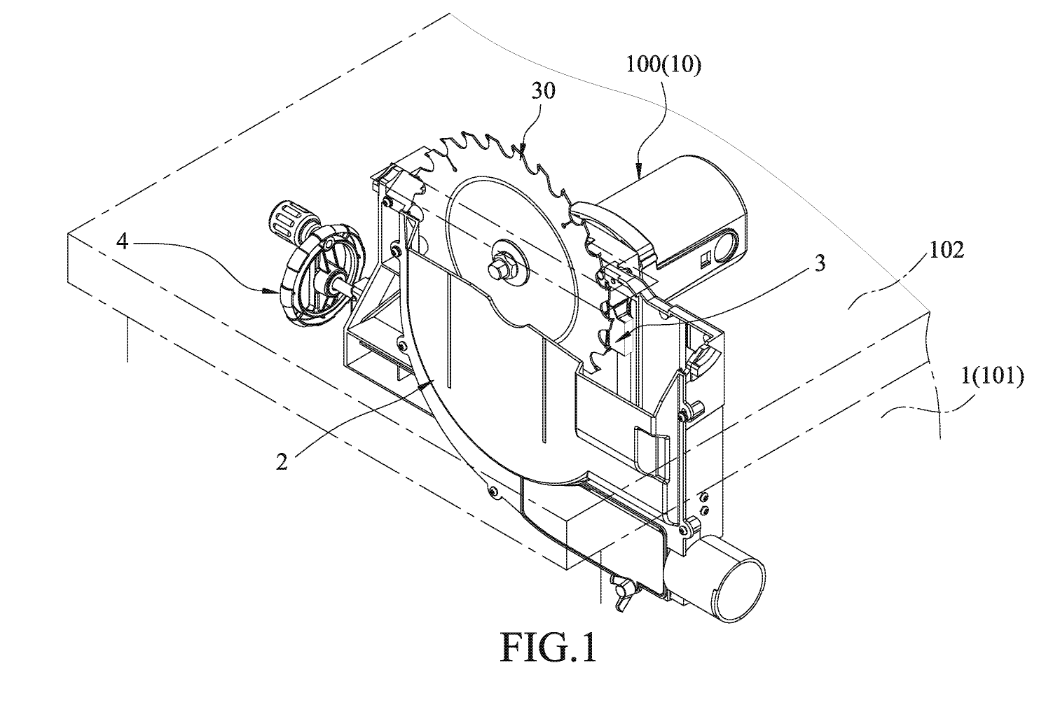

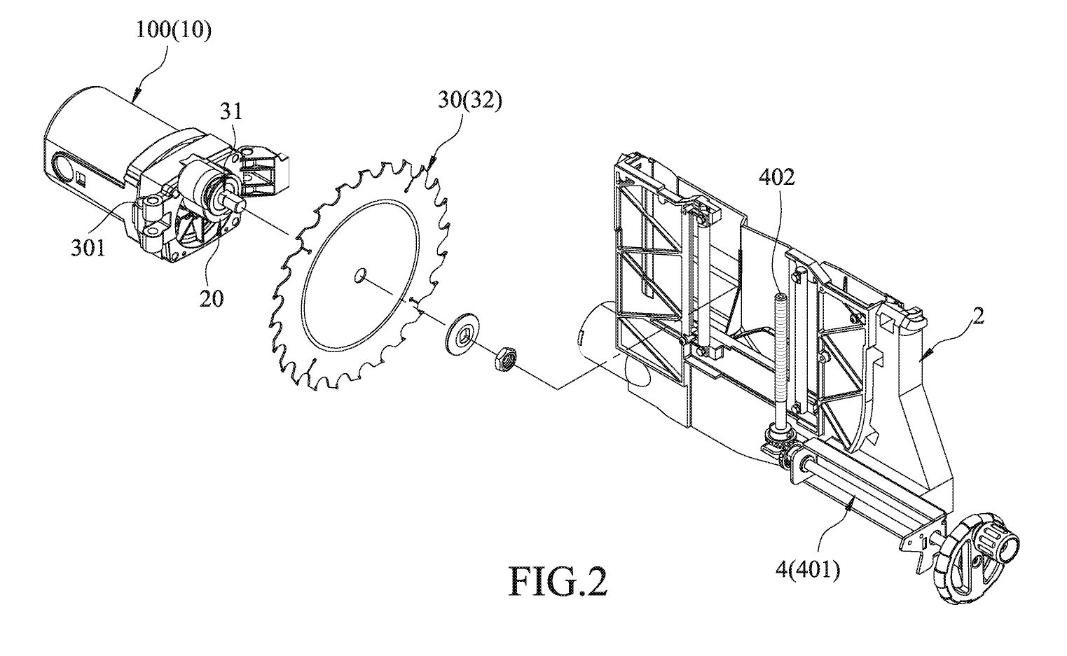

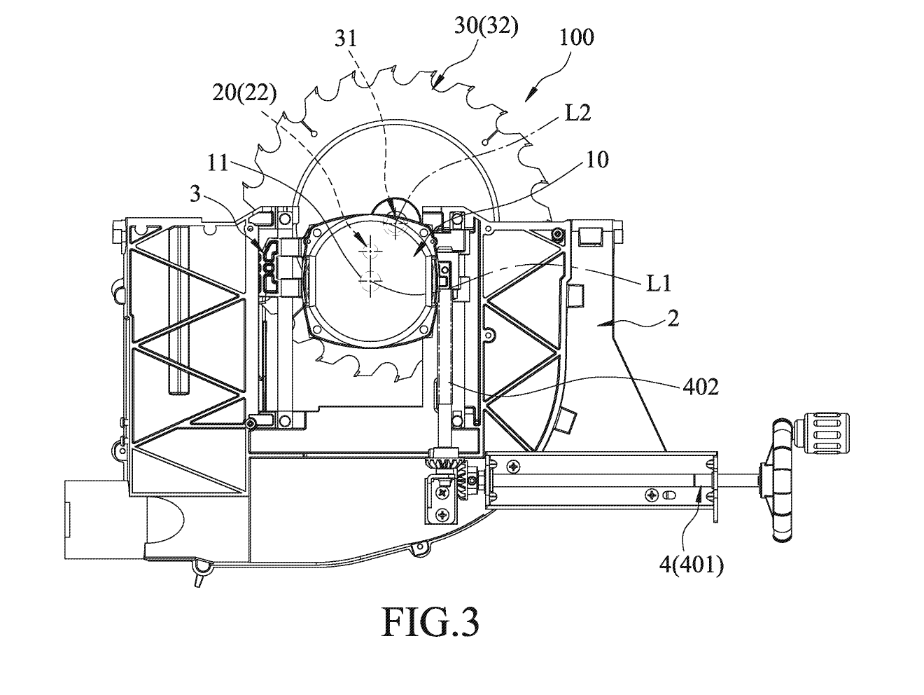

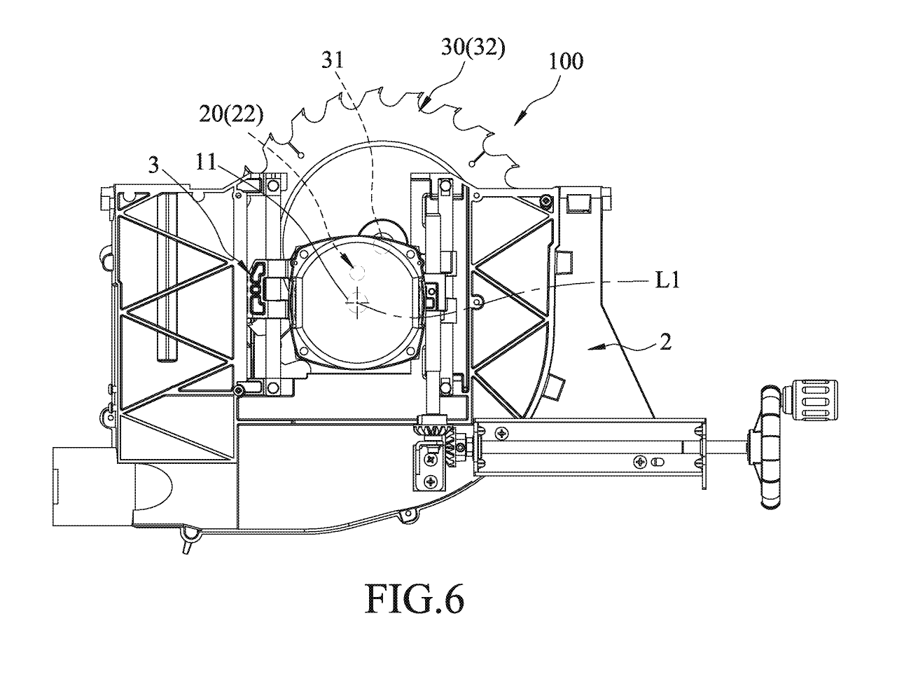

Referring to FIGS. 1 and 2, a first embodiment of a transmission device 100 according to the present disclosure is adapted for use in a table saw. The table saw includes a machine seat 1, a bracket 2 that is mounted to the machine seat 1, a lifting seat 3 that is movably mounted to the bracket 2, and a driving unit 4 that is connected to the bracket 2 and the lifting seat 3. The machine seat 1 has a main body 101 and a working tabletop 102 disposed on the main body 101. The driving unit 4 is operable to drive vertical movement of the lifting seat 3 relative to the bracket 2 between a lifted position (see FIG. 3) and a lowered position (see FIG. 6). Specifically, the driving unit 4 has a driving member 401 disposed on the bracket 2, and a threaded rod 402 connected to the driving member 401 and driven rotatably by the driving member 401. The lifting seat 3 has a nut 301 meshing with the threaded rod 402, such that rotation of the driving member 401 drives the vertical movement of the lifting seat 3.

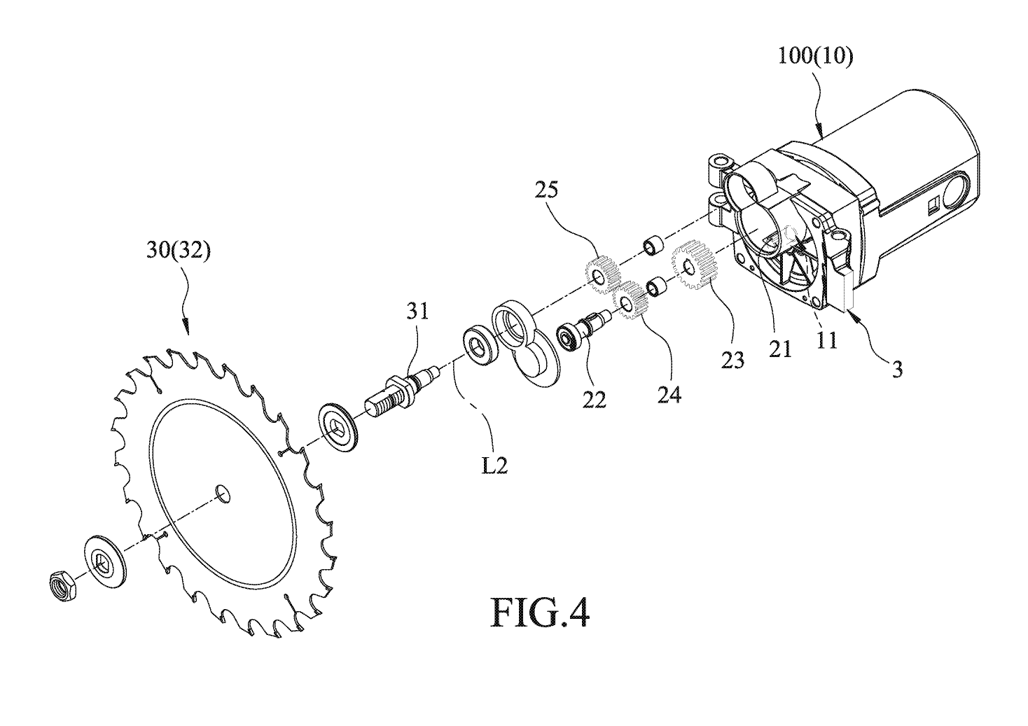

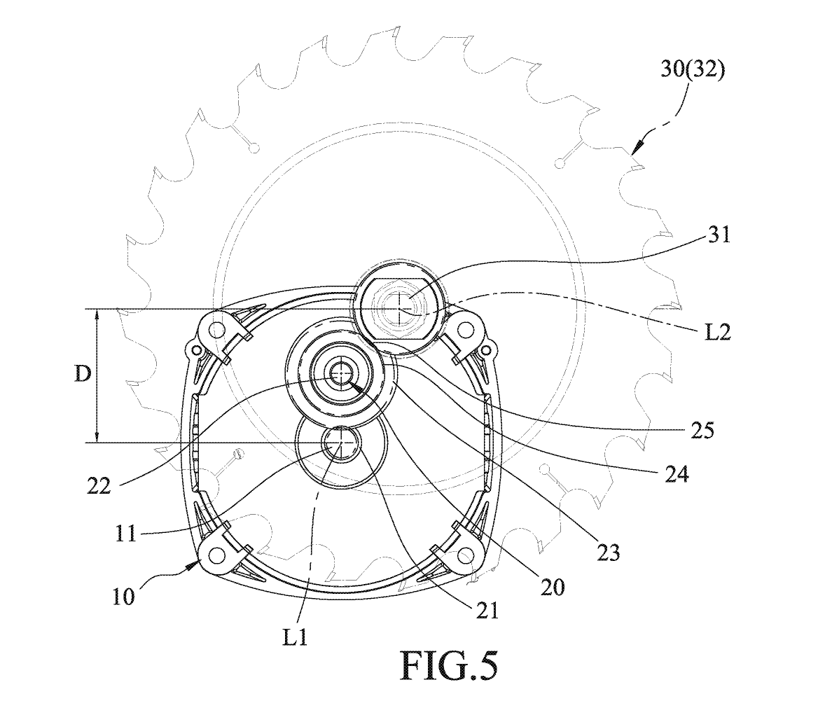

Referring to FIGS. 3 to 5, the transmission device 100 according to the present disclosure includes a motor 10, a speed reduction unit 20, and a saw blade unit 30. The motor 10 is adapted to be mounted to the lifting seat 3, and has a central shaft 11 that extends rotatably along a first axis (L1).

In this embodiment, the speed reduction unit 20 includes a driving gear 21, a coupling shaft 22, a speed reduction gear 23, a first transmission gear 24, and a second transmission gear 25. The driving gear 21 is connected co-rotatably to the central shaft 11 of the motor 10 and is driven rotatably by the motor 10. The coupling shaft 22 is adapted to be connected rotatably to the lifting seat 3. The speed reduction gear 23 is connected fixedly to the coupling shaft 22 and meshes with the driving gear 21. The first transmission gear 24 is connected fixedly to the coupling shaft 22 and is disposed coaxially with the speed reduction gear 23. The second transmission gear 25 meshes with the first transmission gear 24.

The saw blade unit 30 includes an output shaft 31 and a blade member 32. The output shaft 31 is adapted for connection to the lifting seat 3 and extends along a second axis (L2). The second transmission gear 25 is coupled fixedly to the output shaft 31, so that the output shaft 31 is driven rotatably by the speed reduction unit 20. The blade member 32 is connected co-rotatably to the output shaft 31, and has a portion that is adapted to be received in the bracket 2. A vertical distance (D) between the first axis (L1) of the central shaft 11 of the motor 10 and the second axis (L2) of the output shaft 31 ranges from 40 millimeters to 50 millimeters. The first axis (L1) and the second axis (L2) are vertically misaligned. In this embodiment, the vertical distance (D) is configured to be 46 millimeters.

In use, the driving unit 4 is operated to drive the movement of the lifting seat 3 between the lifted and lowered positions, so as to move the blade member 32 to a desired position in accordance with a thickness of a workpiece (such as a wood piece). A portion of the blade member 32 is exposed from a top surface of the working tabletop 102. When the lifting seat 3 is moved from the lowered position to the lifted position, a greater portion of the blade member 32 protrudes from the top surface of the working tabletop 102.

In comparison with the aforementioned conventional table saw, the vertical distance (D) between the first axis (L1) and the second axis (L2) is increased by virtue of the disposition of the speed reduction unit 20 between the motor 10 and the saw blade unit 30. In addition, unlike the vertically aligned configuration of the aforesaid another conventional table saw, in this embodiment, the misalignment of the central shaft 11 and the output shaft 31 reduces the size of the transmission device 100. As a result, when the lifting seat 3 is moved to the lifted position, a distance between the top surface of the working tabletop 102 and a top end of the blade member 32 is larger than that of the conventional table saw, thus the table saw having the transmission device 100 according to the present disclosure is suitable for cutting a thicker wood piece without the need of a larger blade member 32. Furthermore, due to the compact size of the blade member 32, the working tabletop 102 can have a reduced size in conformity with the safety regulation, thereby lowering the cost of packaging and transporting.

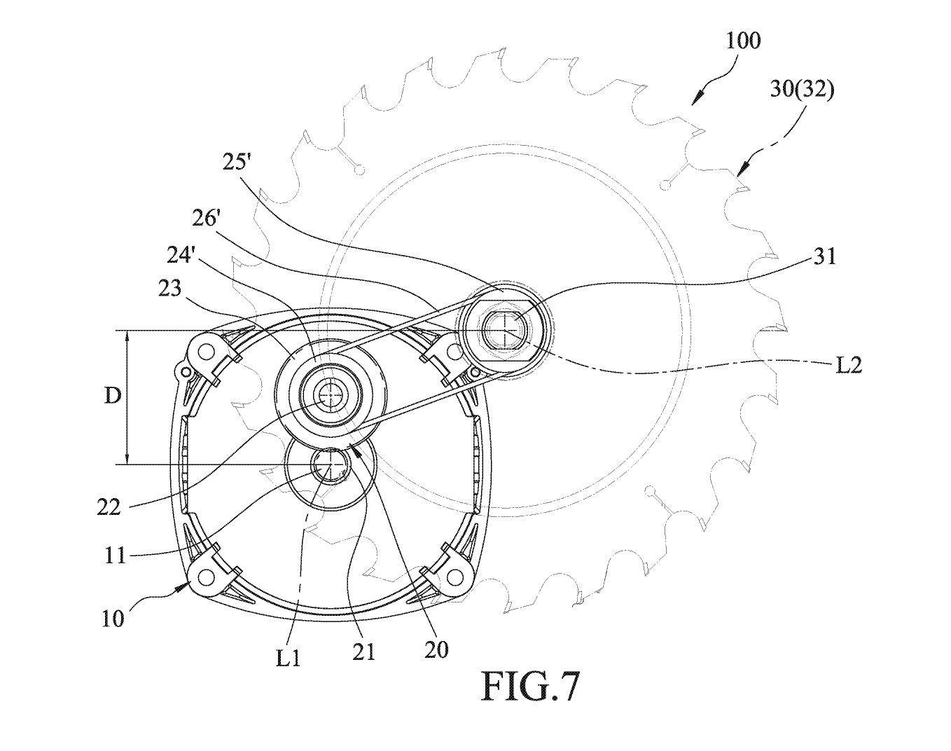

Referring to FIG. 7, a second embodiment of the transmission device 100 has a structure similar to that of the first embodiment. The main difference between this embodiment and the previous embodiment resides in the configuration of the speed reduction unit 20. The speed reduction unit 20 includes a driving gear 21 connected co-rotatably to the central shaft 11 of the motor 10, a coupling shaft 22 adapted to be connected rotatably to the lifting seat 3, a speed reduction gear 23 connected fixedly to the coupling shaft 22 and meshing with the driving gear 21, a first pulley 24′ connected fixedly to the coupling shaft, 22 and disposed coaxially with the speed reduction gear 23, a second pulley 25′ coupled fixedly to the coupling shaft 22, and a transmission belt 26′ trained on the first pulley 24′ and the second pulley 25′.

In this embodiment, the output shaft 31 of the saw blade unit 30 is disposed above the coupling shaft 22 of the speed reduction unit 20. The central shaft 11 of the motor 10 is disposed below the coupling shaft 22. The first axis (L1) of the central shaft 11 and the second axis (L2) of the output shaft 31 are vertically misaligned.

The second embodiment has the same advantage as those of the first embodiment.

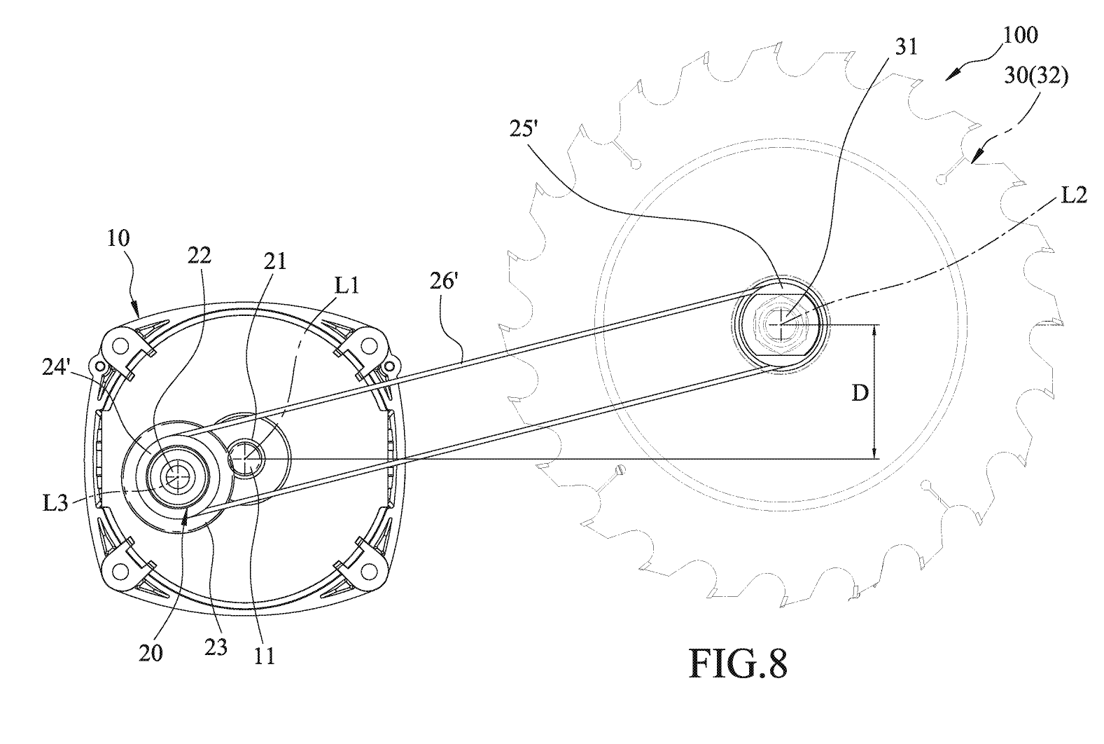

Referring to FIG. 8, a third embodiment of the transmission device 100 has a structure similar to that of the second embodiments The main difference between this embodiment and the second embodiment resides in the following.

In this embodiment, the first axis (L1) is disposed between the second axis (L2) and a third axis (L3) along which the coupling shaft 22 extends e Specifically, the second axis (L2) of the output shaft 31, the first axis (L1) of the central shaft 11, and the third axis (L3) of the coupling shaft 22 are vertically misaligned and are substantially arranged along an imaginary straight line. The output shaft 31 is disposed above the coupling shaft 22, and the central shaft 11 is disposed above the coupling shaft 22.

The third embodiment has the same advantage as those of the first embodiment.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

1. A transmission device adapted for use in a table saw, the table saw including a machine seat, a bracket that is mounted to the machine seat, a lifting seat that is movably mounted to the bracket, and a driving unit that is connected to the bracket and the lifting seat, and that is operable to drive vertical movement of the lifting seat, said transmission device comprising:
a motor adapted to be mounted to the lifting seat, and having a central shaft that extends rotatably along a first axis;
a speed reduction unit adapted to be mounted to the lifting seat, connected to said central shaft, and driven rotatably by said motor; and
a saw blade unit including
an output shaft that is adapted for connection to the lifting seat, that extends along a second axis, and that is driven rotatably by said speed reduction unit, and
a blade member that is connected co-rotatably to said output shaft, and that has a portion adapted to be received in the bracket.

2. The transmission device as claimed in claim 1, wherein a vertical distance between the first axis of said central shaft and the second axis of said output shaft ranges from 40 millimeters to 50 millimeters.

3. The transmission device as claimed in claim 2, wherein the first axis and the second axis are vertically misaligned.

4. The transmission device as claimed in claim 2, wherein said speed reduction unit includes:
a driving gear connected co-rotatably to said central shaft of said motor;
a coupling shaft adapted to be connected rotatably to the lifting seat;
a speed reduction gear connected fixedly to said coupling shaft and meshing with said driving gear;
a first transmission gear) connected fixedly to said coupling shaft and disposed coaxially with said speed reduction gear; and
a second transmission gear coupled fixedly to said output shaft and meshing with said first transmission gear.

5. The transmission device as claimed in claim 2, wherein said speed reduction unit includes:
a driving gear connected co-rotatably to said central shaft of said motor;
a coupling shaft adapted to be connected rotatably to the lifting seat;
a speed reduction gear connected fixedly to said coupling shaft and meshing with said driving gear;
a first pulley connected fixedly to said coupling shaft and disposed coaxially with said speed reduction gear;
a second pulley coupled fixedly to said output shaft; and
a transmission belt trained on said first pulley and said second pulley.

6. The transmission device as claimed in claim 5, wherein:
said output shaft of said blade unit is disposed above said coupling shaft of said speed reduction unit;
said central shaft of said motor is disposed below said coupling shaft; and
the first axis and the second axis are vertically misaligned.

7. The transmission device as claimed in claim 5, wherein:
said coupling shaft extends along a third axis (L3);
the second axis, the first axis, and the third axis are vertically misaligned, and are substantially arranged along an imaginary straight line; and
the first axis is disposed between the second axis and the third axis.

8. The transmission device as claimed in claim 7, wherein:
said output shaft is disposed above said coupling shaft; and
said central shaft is disposed above said coupling shaft.
